(19) United States
(12) Patent Application Publication
(10) Pub. No.: US 2010/0083162 A1
(43) Pub. Date: Apr. 1, 2010

(54) HAND-HELD PORTABLE ELECTRONIC BIBLE

(76) Inventor: Selina Hernandez, Oceanside, CA (US)

Correspondence Address: ROSS PATENT LAW OFFICE, P.O. BOX 2138, DEL MAR, CA, 92014, US

(21) Appl. No.: 12/242,679

(22) Filed: Sep. 30, 2008

(51) Int. Cl. G06F 3/048; G06F 3/041

(52) U.S. Cl. 715/776; 345/179; 382/189; 715/702

(57) ABSTRACT

A hand-held electronic Bible. A user having a stylus handwrites inputs and commands onto the screen of the electronic Bible. Handwriting recognition software receives the handwritten inputs and commands and then converts the inputs and commands into computer readable inputs and commands. The hand-held electronic Bible includes a processor, programming and a memory configured to display biblical text on the screen, receive handwritten inputs and commands from a user, and to process the inputs and commands to display biblical information requested by the user. In a preferred embodiment, the hand-held electronic Bible is a programmed tablet PC. In another preferred embodiment, the hand-held electronic Bible includes a books button, a memorize button, a dictionary button and a notes button.

The present invention relates to hand-held electronic devices, and in particular to hand-held electronic Bibles.

### BACKGROUND OF THE INVENTION

A Tablet PC is a notebook or slate-shaped mobile computer, equipped with a touchscreen or graphics tablet/screen hybrid technology which allows the user to operate the computer with a stylus or digital pen, or a fingertip, instead of a keyboard or mouse. The stylus offers a more mobile way to interact with a computer by allowing the user to write and draw on the screen so that the user is inputting information and programming instructions into the computer with the stylus rather than typing the information into the computer with a keyboard. Tablet PCs are often used where normal notebooks are impractical or unwieldy, or do not provide the needed functionality.

### Inking

Tablet PCs have special screens which use an active digitizer to enable users to write directly on the screen to control their PC and to input information as handwriting or drawing.

This process—called inking—enables users to add “digital ink” to a full range of Windows applications, which appears as natural-looking handwriting on the screen. The digitized handwriting can be converted to standard text through handwriting recognition software, or it can remain as handwritten text. Both the converted text in typeface and the cursive handwritten text function equally well as data formats in Windows applications and platforms—that is, both forms of text can be sent as e-mail in Microsoft Outlook and exchanged as documents in Microsoft Word, and can be sent from the Tablet PC to a desktop computer or a Pocket PC, which can display the text in the same character format that it was sent in. A prior art handwriting recognition software found in many Tablet PC's is Microsoft's Window Journal.

### Types of Tablet PCs

### Slates

Slates resemble writing slates and do not include an integrated keyboard portion. Prior art slate Tablet PC 99 is shown in FIG. 3. Date is entered via stylus 88 by writing or tapping onto screen 97. In addition, keyboards may be attached via a wireless or USB connection. The tablet (8.4-14.1 inches/21-36 cm) LCD screens and have been popular for quite some time in vertical markets such as health care, education, and field work.

Slate models are often designed with a focus on pure mobility, that is, the less to carry, the better.

Also, since slates do not include a keyboard there are fewer moving parts to break.

### Convertibles

Convertible notebooks have a base body with an attached keyboard. They more closely resemble modern notebooks/laptops, and are usually heavier and larger than slates. A prior art slate Tablet PC is shown in FIG. 1.

As shown in FIG. 1, base 1 of a convertible tablet PC 5 includes keyboard 4. Base 1 attaches to screen 2 at a single joint shown in FIG. 2 as swivel hinge 7. The joint allows the screen to rotate around 180° and fold down on top of keyboard 4 (FIG. 1) to provide a flat writing surface.

Convertibles are by far the most popular form factor of tablet PCs, because for people who are unsure about the practicality of using the pen as the primary method of input, the convertibles still offer the keyboard and pointing device of traditional notebooks as a backup plan.

### Hybrids

Hybrids share the features of the slate and convertible by using a detachable keyboard which operates in a similar fashion to a convertible when attached.

This is not to be confused with slate models that have a detachable keyboard-detachable keyboards for pure slate models do not rotate around to allow the tablet to rest on it like a convertible.

### Impact of the Tablet PC

The Tablet PC has changed the way user's interact with their personal computers. In his book Seize the Work Day: Using the Tablet PC to Take Total Control of Your Work and Meeting Day, Michael Linenberger does a detailed analysis of the advantages of the Tablet PC. He writes:
Using a Tablet PC during a typical management meeting is totally different from using a laptop. It's the difference between night and day. The difference between success and failure. Here's why:
Discretion: Nothing is more distracting than, during a management-style meeting, having a meeting participant typing away on a laptop. In contrast, working with a Tablet PC in your lap appears no different from what you would be doing with a pen and notepad in your lap. This is particularly true if you use, as recommended later in this book, an executive-style portfolio case that makes your Tablet PC resemble an executive notepad portfolio
Communication barriers: Placing a laptop with the screen flipped up in front of you on a conference room table creates a physical barrier between you and others in the room. This is literally a barrier to communication. The Tablet PC is normally on your lap, and out of sight. Or it is flat on the desk like a writing pad.
Personal effectiveness: Research shows that if you use both hands to accomplish a task, a much larger percentage of your brain becomes engaged in that operation. Typing with both hands tends to totally engage your brain in the typing activity and makes you visibly less tuned-in to the meeting. In contrast, writing with one hand during a meeting is second nature to most of us. The brain stays mostly engaged in the meeting activities. We all can take notes and participate in a meeting at the same time. Using a Tablet PC in a meeting is little different from this.
Eye contact: Related to the above point; and for the same reasons, many users have reported that it is much easier to maintain periodic and consistent eye contact with others in a meeting when using a Tablet PC versus using a laptop. This has a dramatic affect on the perception of others that you are engaged and personable. Lack of eye contact also limits your ability to read body language of others, adding to your distance from the meeting (pp. 15, 16)

Linenberger then specifically addresses the advantages of inking (i.e., the process of writing directly on the tablet screen to control the PC and to input information as handwriting or drawing.)
Taking notes in ink:
   facilitates creativity in your note taking
   communicates more about the meaning of your notes
   integrates better with sketches and expressive marks on the note-taking page
   is a better way to represent information copied from whiteboards and presentations
   is a faster way to record notes, faster than even the most speedy and accurate handwriting recognition.
I can virtually guarantee that after a few days or weeks of taking notes primarily in ink, you too will be convinced that this is a highly effective and preferable method of note taking on the Tablet PC (Linenberger, p. 237).

### The Bible

For over two thousand years, millions of people have modeled their lives based on the scriptures of the Holy Bible and the teachings of Jesus Christ. Signified by a belief in the Holy Trinity, charity, prayer and forgiveness, Christianity is one of the most practiced religions in the world. With a variety of denominations including Roman Catholic, Protestant, Baptist, Presbyterian and Lutheran, people from all walks of life have come together under the umbrella of this universal faith. For many Christians, religious faith provides an outlet through which to celebrate times of joy and offers a means of giving thanks for life's many blessings. Religious faith also serves to comfort, particularly in times of sorrow. In fact, many find that when things seem their worst; during times of hardship, when accidents occur, when they are failed by loved ones or when odds seem insurmountable, faith in God is stronger than ever.

The standard by which most Christians throughout the ages have lived and worshiped is the Holy Bible. Believed to be directly derived from the inspiration of the Holy Spirit, the Holy Bible was written by over forty different authors, most notably; Moses and the apostle Paul, but also including people from all walks of life, such as shepherds, farmers, physicians, priests, philosophers and kings. Written over a span of fifteen hundred years, from approximately 1450 B.C. until 100 A.D., the Holy Bible is nonetheless a unified and cohesive document. For many Christians, reading the Bible, studying the holy scriptures, and learning more about their faith can bring a sense of encouragement, fulfillment and peace of mind to their daily life.

While reading the Bible can be encouraging and spiritually enlightening, locating particular verses can sometimes be difficult, especially when searching for a verse aimed toward a specific subject. Unfortunately, aimlessly thumbing through book after book, simply in order to find a particular chapter or verse which can offer comfort or guidance in a time of personal crisis, can be an extremely frustrating experience. Further, assembling Christian reading material outside the Bible with which to cross reference or gain another perspective on a particular subject can be extremely challenging.

### Prior Art Electronic Bibles

Electronic Bibles are disclosed in the prior art. Martin (U.S. Design Pat. No. D527,381), Gonet (U.S. Pat. No. 4,445,196), and Walters (U.S. Pat. No. 4,970,680) each disclose an electronic or a computer Bible. However, none of these devices provide or disclose the proper type of electronic Bible that is needed to adequately read, study and interact with the Bible. The prior art electronic bibles are difficult to use and inappropriate for religious services and study. They include keyboard buttons that must be pressed during usage. This type of operation can be very distracting to a congregation or to another religious gathering where it is important to be quiet and respectful.

What is needed is a better electronic bible.

### SUMMARY OF THE INVENTION

The present invention provides a hand-held electronic Bible. A user having a stylus handwrites inputs and commands onto the screen of the electronic Bible. Handwriting recognition software receives the handwritten inputs and commands and then converts the inputs and commands into computer readable inputs and commands. The hand-held electronic Bible includes a processor and programming configured to display biblical text on the screen, receive handwritten inputs and commands from a user, and to process the inputs and commands to display biblical information requested by the user. In a preferred embodiment, the hand-held electronic Bible is a programmed tablet PC. In another preferred embodiment, the hand-held electronic Bible includes a books button, a memorize button, a dictionary button and a notes button.

### BRIEF DESCRIPTION OF THE DRAWINGS

FIGS. 1-3 show prior art tablet PC's.

FIGS. 4-16 show features of preferred embodiments of the present invention.

FIGS. 18-20 show another preferred embodiment of the present invention.

FIGS. 21-25 show another preferred embodiment of the present invention.

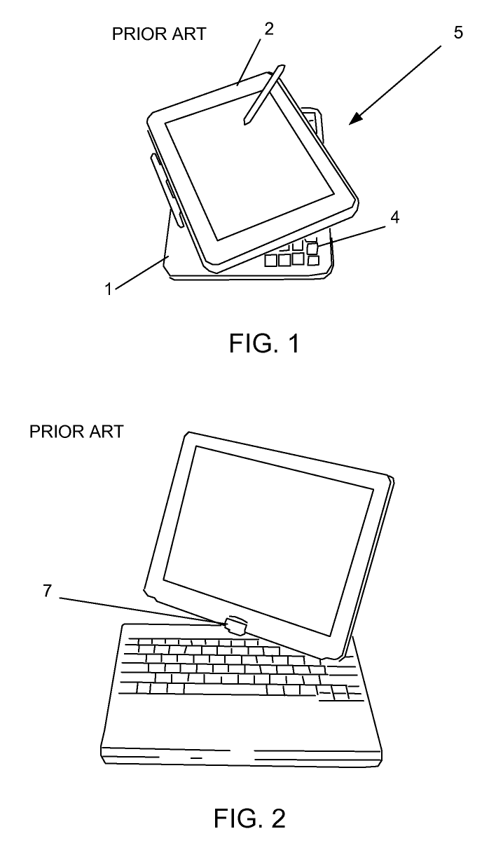

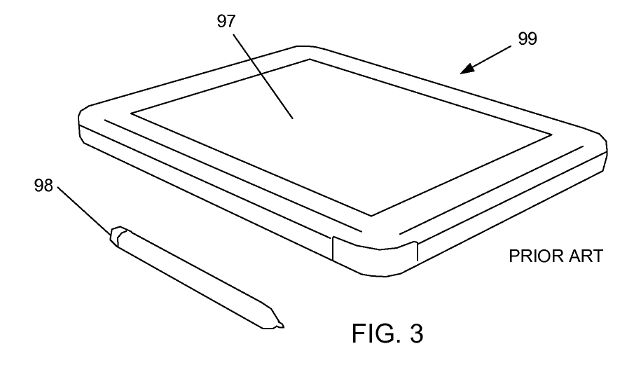

In a preferred embodiment of the present invention the computer processing unit that is utilized is a preprogrammed tablet PC. The user makes entries onto a CPU's screen by using a stylus. The program that analyzes the user's inputs is described in detail below.

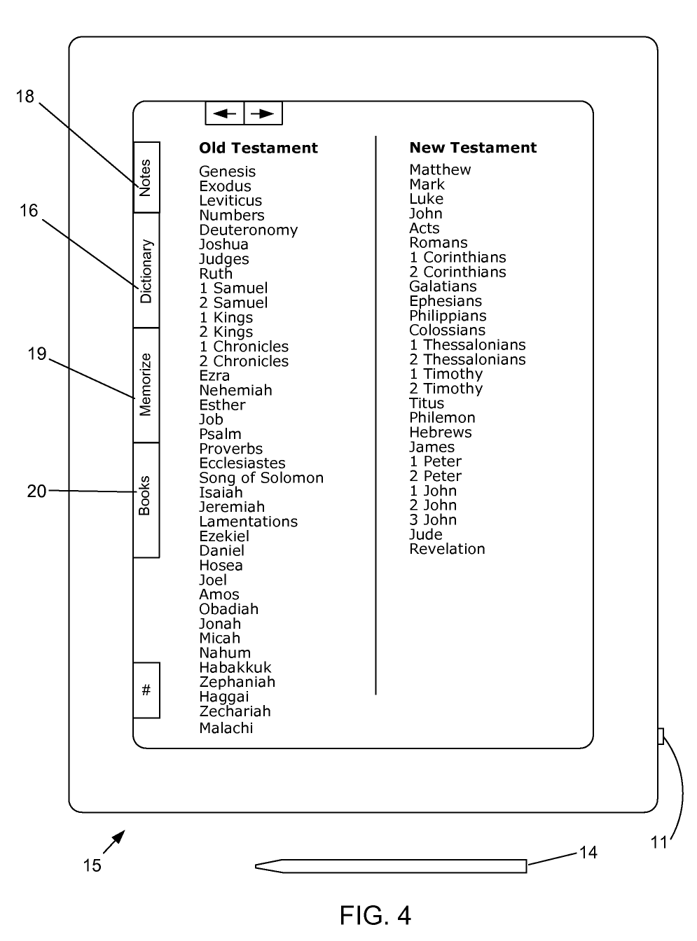

FIG. 4 shows a preferred embodiment of the present invention. In the preferred embodiment of the present invention, the user is able to use a stylus to write onto a screen in order to write notes or to touch or tap the screen to input commands into the electronic bible. The user also uses the stylus to navigate his way through the different sections of the electronic Bible. The electronic Bible is very easy to use and is configured for optimum efficiency to enhance biblical learning and study. The fact the user is able to take notes by utilizing a handwriting implement increases the learning of the user and is less obtrusive to others around the user.

To turn “on” electronic Bible 15 (FIG. 4), a user slides switch 11. The screen appears as shown in FIG. 4. This is preferably called the “Books” screen, where the books of the Old and New Testament are listed. The user interacts with the electronic bible by tapping or writing on the screen with stylus 14.

### Books

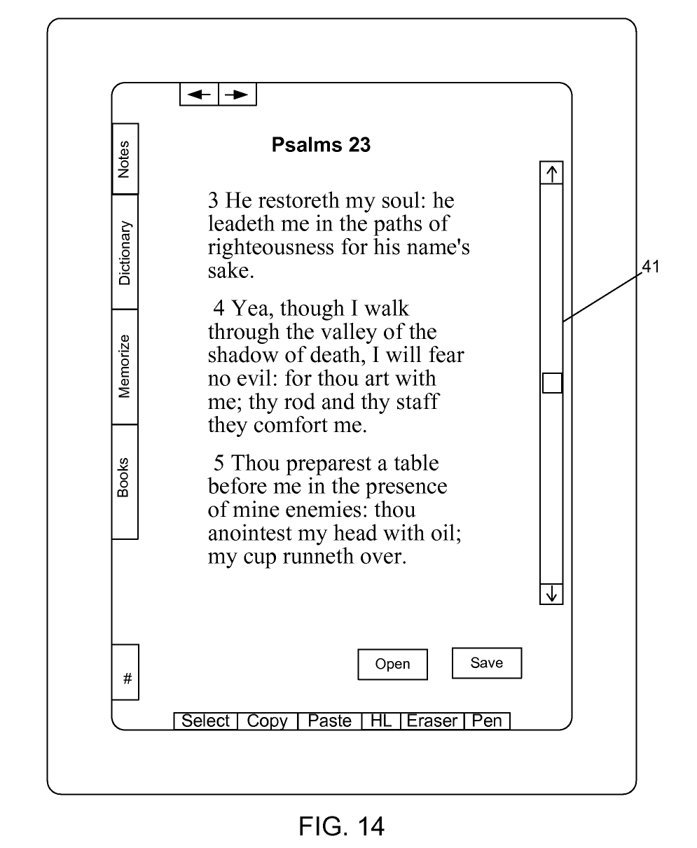

From the Books screen the user can access a specific chapter and verse. In FIG. 4, the user taps on “Proverbs”. Then, box 31 appears on the screen as shown. The user then writes the chapter and verse of Proverbs that he is interested in reading. The handwriting recognition software is programmed to recognize the user's handwritten instructions. Then, the user taps on button 32 with stylus 14. The screen then appears as shown in FIG. 14.

Alternatively, in another preferred embodiment, the user can tap on “#” button 33 to bring up keypad 34 and box 35. To enter Chapter 23, Verse 4, the user taps on “2” then “3” then “Enter”. Then the user taps on “4” then “Enter”. Then, the user taps on “Proverbs”. This brings the user to the screen shown in FIG. 14.

### Scrolling

From the screen shown in FIG. 14, the user can utilize scroll bar 41 to scroll up and down the page to access earlier and later Chapters and Verses.

### Bible Dictionary

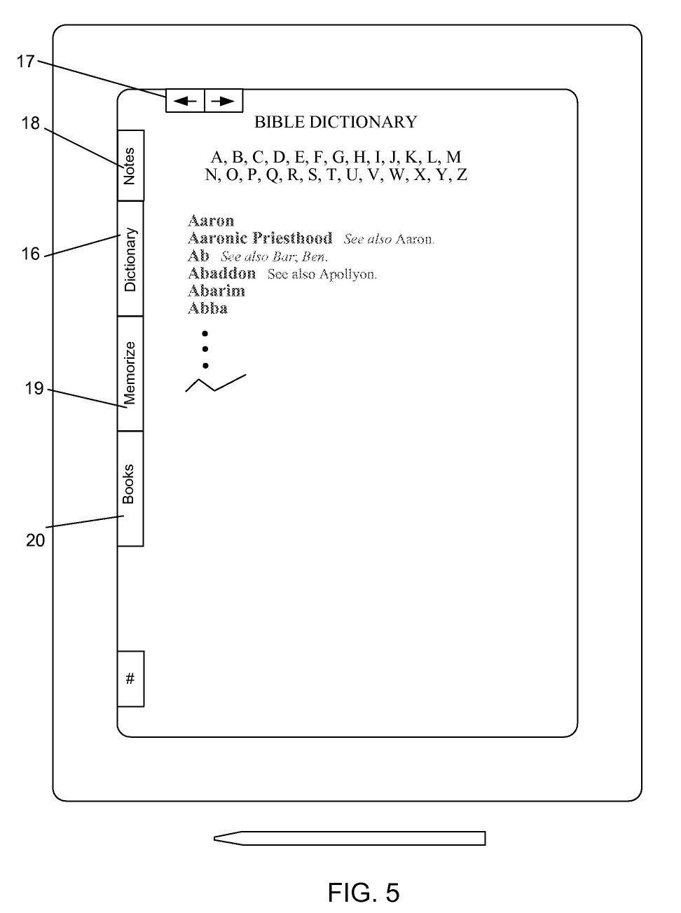

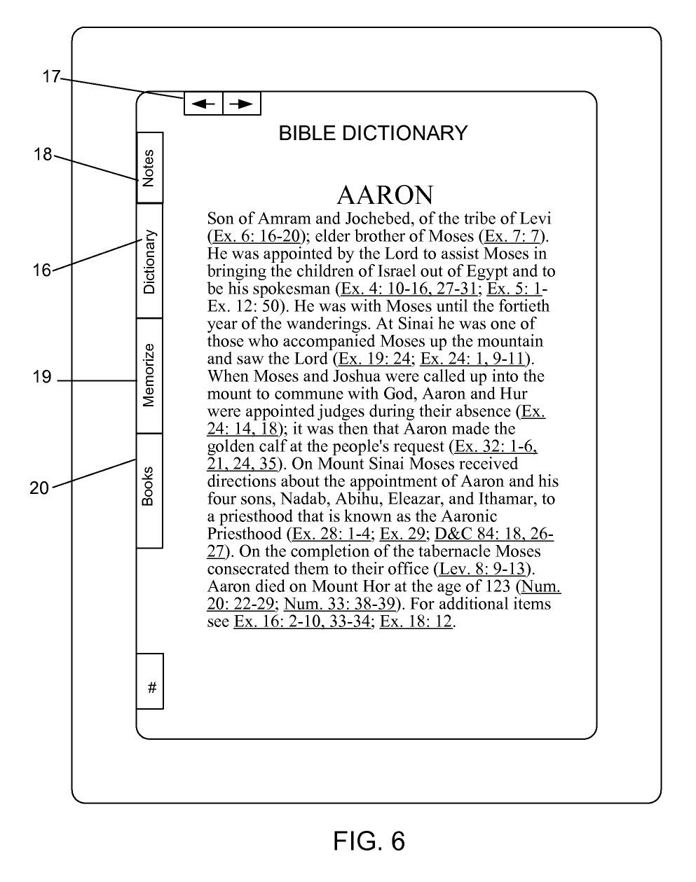

To access the Bible Dictionary, the user taps on dictionary button 14. The screen then changes to the screen as shown in FIG. 5. In FIG. 5, the user has tapped on the letter “A” and a list of Bible related words appears on the screen as shown. To get a definition of a particular word, the user taps on the word of interest. For example, in FIG. 5 the user taps on the name “Aaron”. The screen then appears as shown in FIG. 6. A summary of important information about Aaron is displayed.

From the screen as shown in FIG. 6, the user can further tap on the chapters and verses listed. For example, the user can tap on “Ex. 7:7” to go to the chapter and verse to read the section on Moses. Also, from the screen shown in FIG. 6, the user can tap on back arrow 17 to move back to the previous page. Or the user can press any of buttons 16, 18, 19 or 20 to go to the desired section.

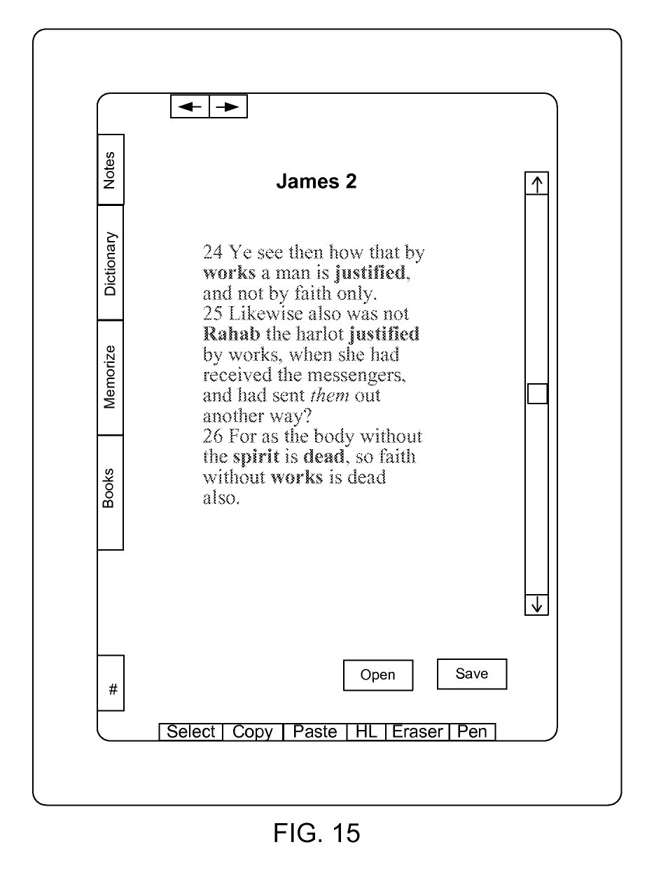

The Bible Dictionary can also be accessed directly from a specific Chapter and Verse. For example, FIG. 15 shows James 2:24-26. The words written in bold are referred to in the Bible Dictionary.

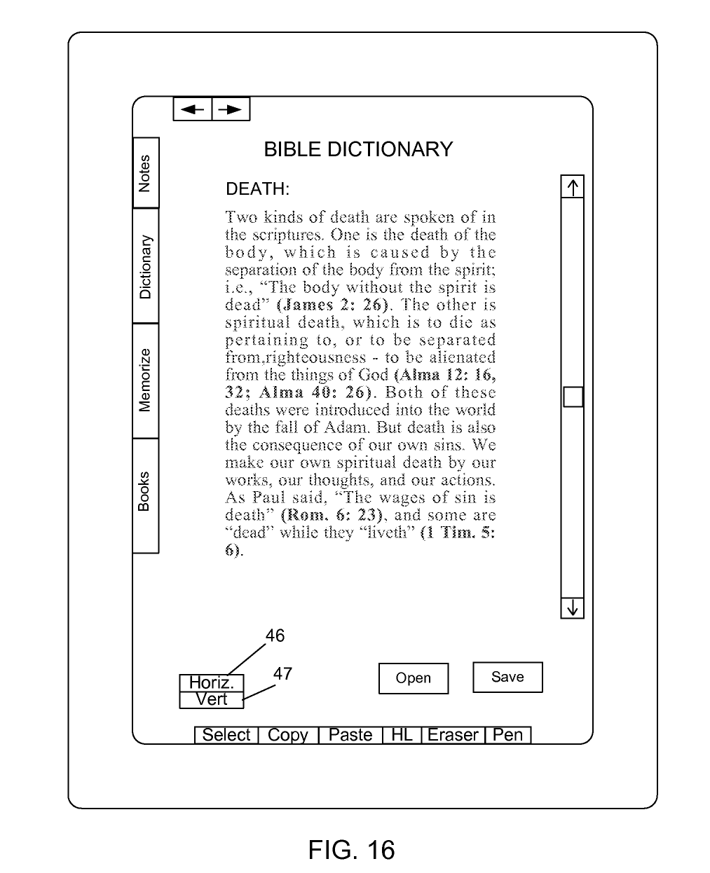

For example, the user taps on the word “dead” from James 2:26. The user is then taken to the screen shown in FIG. 16. “Death” is discussed and its treatment in the Bible is defined. From the screen shown in FIG. 16, the user can either hit back arrow 17 to return to James 2:24-26, or tap on any of the Chapter/Verses listed to go to the desired Chapter and Verse.

### Notes

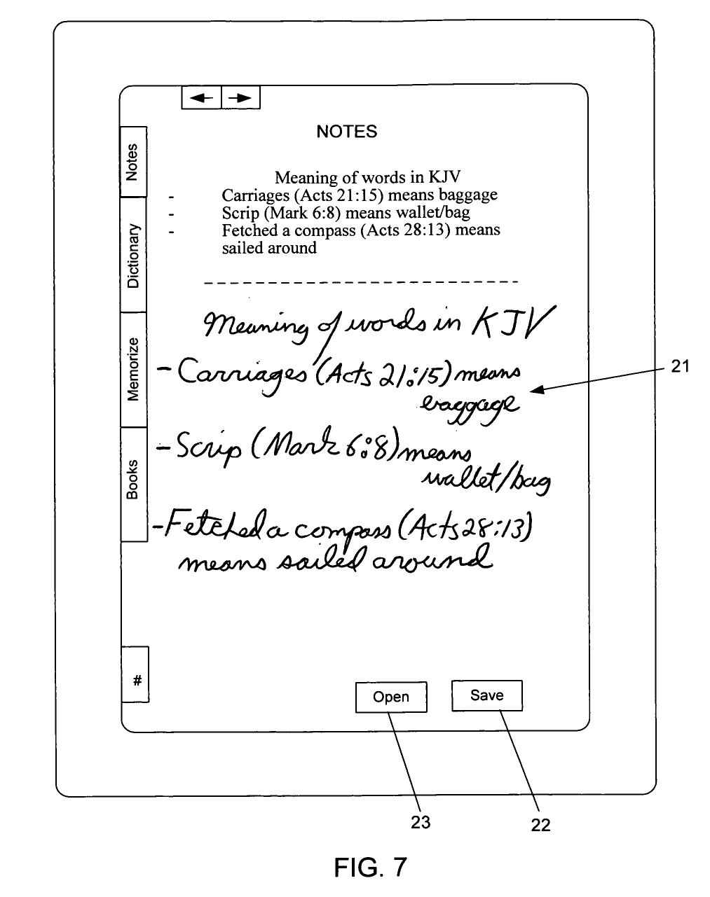

In FIG. 7 the user has tapped on Notes button 18 from the Books page (FIG. 4). In section 21 below the dotted line, the user has written notes while listening to a sermon at church. The preacher was explaining that certain words from the King James Version of the Bible have special meanings. Using stylus 14 (FIG. 4), the user has handwritten notes into section 21. The preferred embodiment of the present invention includes handwriting recognition -software that immediately translates the handwritten notes into computer generated text. The notes can then be saved by the user by tapping save button 22.

Also from the Notes page the user can access old notes taken on previous occasions by tapping on open button 23. After tapping on the open button a list of files will appear. The listed files will contain notes taken on previous occasions. The user opens the file he wishes to access by tapping on the file of interest.

### Memorize

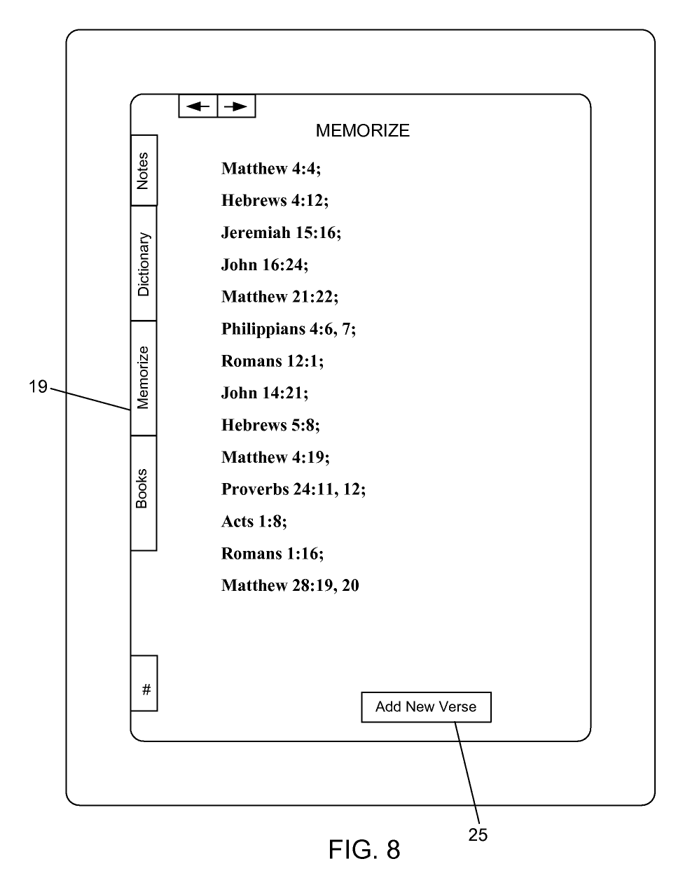

In FIG. 8 the user has tapped on Memorize button 19 from the books page (FIG. 4). Listed on the screen is a list of important verses to memorize. In a preferred embodiment of the present invention, the electronic bible comes preprogrammed with a list of important verses. To add other verses to the list, the user taps on “Add New Verse” button 25 and then enters the verse of interest.

### Procedure to Memorize a Verse

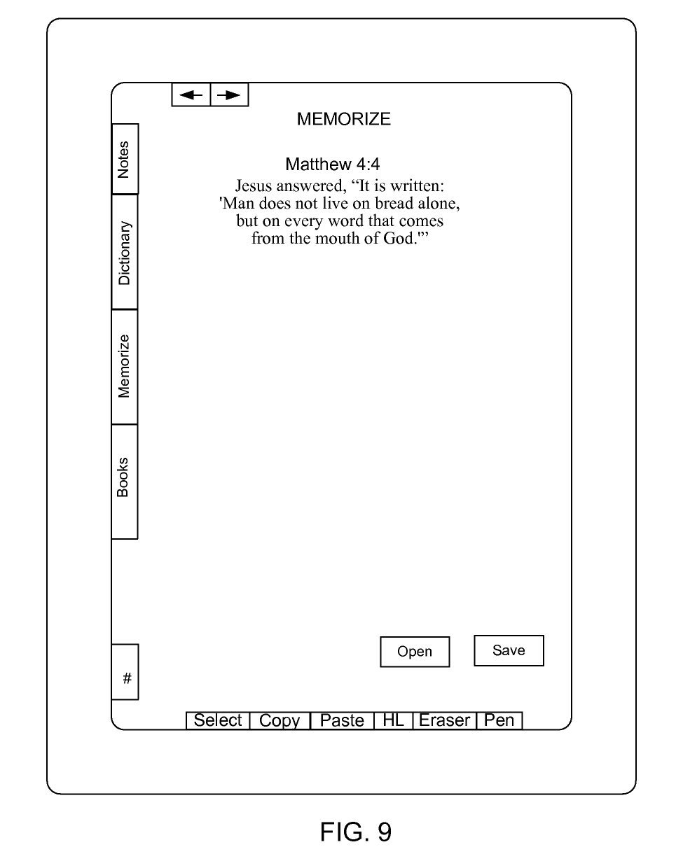

In FIG. 8, the user is interested in memorizing Matthew 4:4. To practice memorizing the verse the user first tries to recite the verse to himself. After he has made the attempt the user then taps on “Matthew 4:4” with stylus 14. The screen then appears as shown in FIG. 9. The user then reads the verse as written to determine if he was right.

### Pasting a Section of the Verse

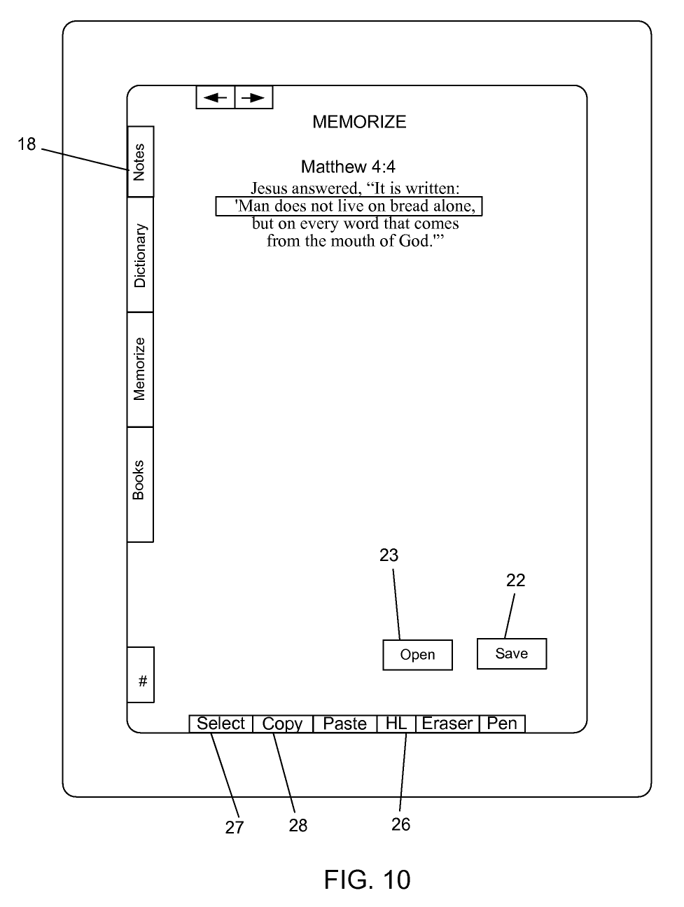

On occasions, their may be a specific section of a verse that is of particular interest to the user. For example, FIG. 10 shows that the user is interested in the section of Matthew 4:4 that says, “Man does not live on bread alone”

### Highlighting

The user can then highlight that section by tapping on “HL” button 26 with stylus 14. The user then moves stylus 14 across the screen over the words, “Man does not live on bread alone”. That section of the words then appears in a different color (preferably yellow). To save the verse with the highlight displayed the user taps on “Save” button 22.

### Copy and Pasting to Notes

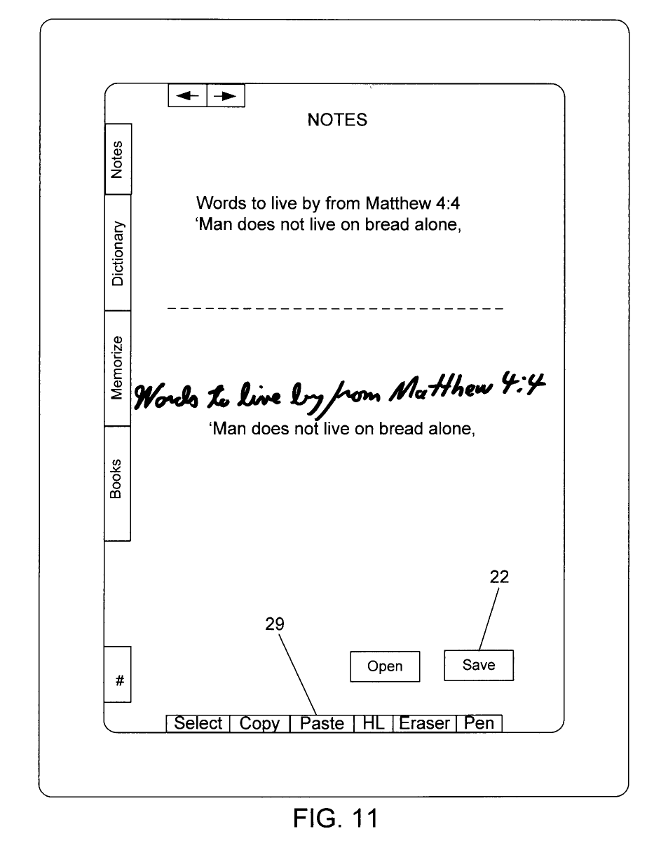

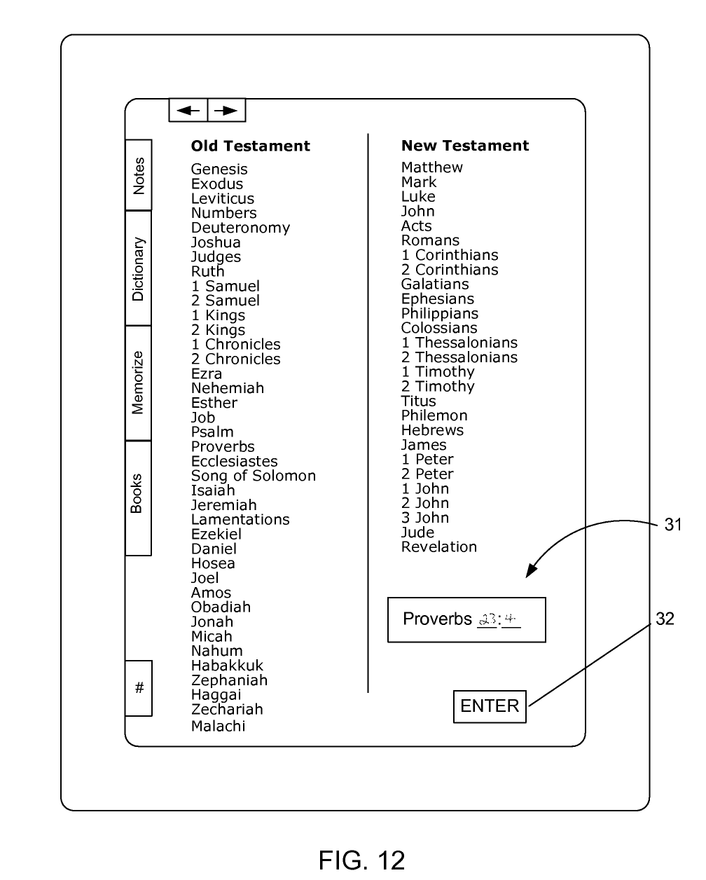

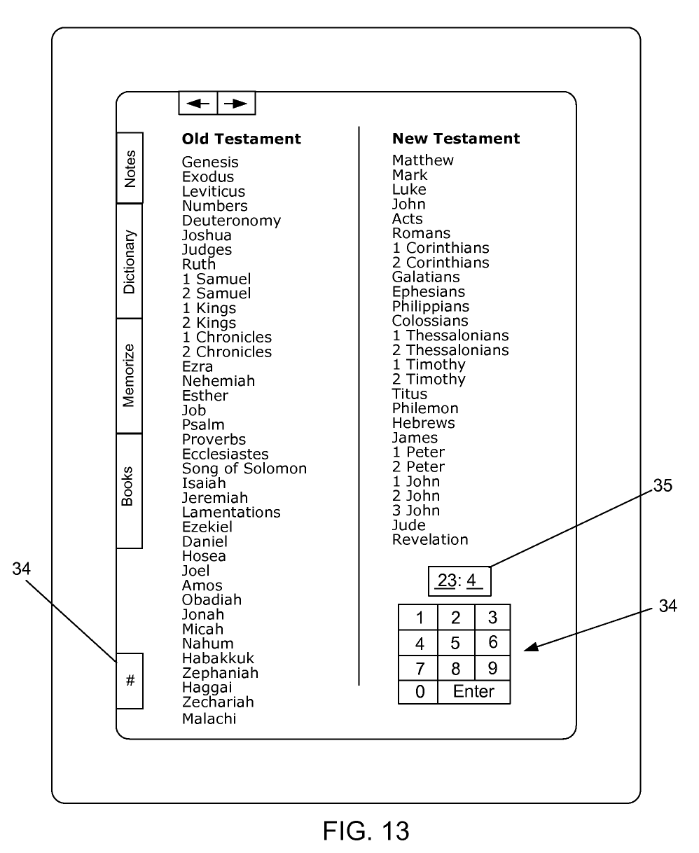

Alternatively, the user can copy and paste to Notes the verse in its entirety or copy and paste a section of the verse. For example, to copy a section of the verse the user taps on “Select” button 27. He then moves stylus 14 across the screen over the words, “Man does not live on bread alone”. He then taps on “Copy” button 28 to copy to the clipboard the words, “Man does not live on bread alone”. Then, the user taps on Notes button 18 to bring the user to the screen shown in FIG. 11.

As shown in FIG. 11, the user first handwrites the words, “Words to live by from Matthew 4:4” with stylus 14. Then the user pastes the saved words “Man does not live on bread alone” by tapping on paste button 29. As shown in FIG. 11, the handwriting recognition software has converted the handwritten words “Words to live by from Matthew 4:4” to text. The full phrase “Words to live by from Matthew 4:4 ‘Man does not live on bread alone” can then be saved to Notes by tapping on save button 22 with stylus 14.

### Horizontal or Vertical Display

In a preferred embodiment of the present invention it is possible to alternate between horizontal and vertical displays of the text on the screen. For example, FIG. 16 shows a vertical display of the text on the screen. To switch to a horizontal display, the user taps on “Horizontal” button 46. The screen then appears as shown in FIG. 17. The horizontal display may be preferable to some users because it is ideal for utilizing larger font. To return to a vertical display the user taps on “Vertical” button 47.

### Cover

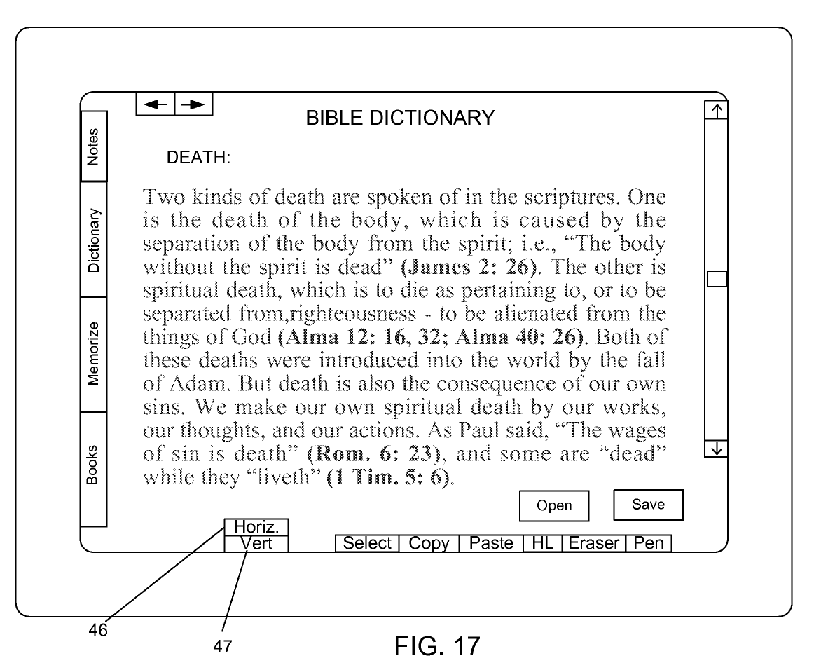

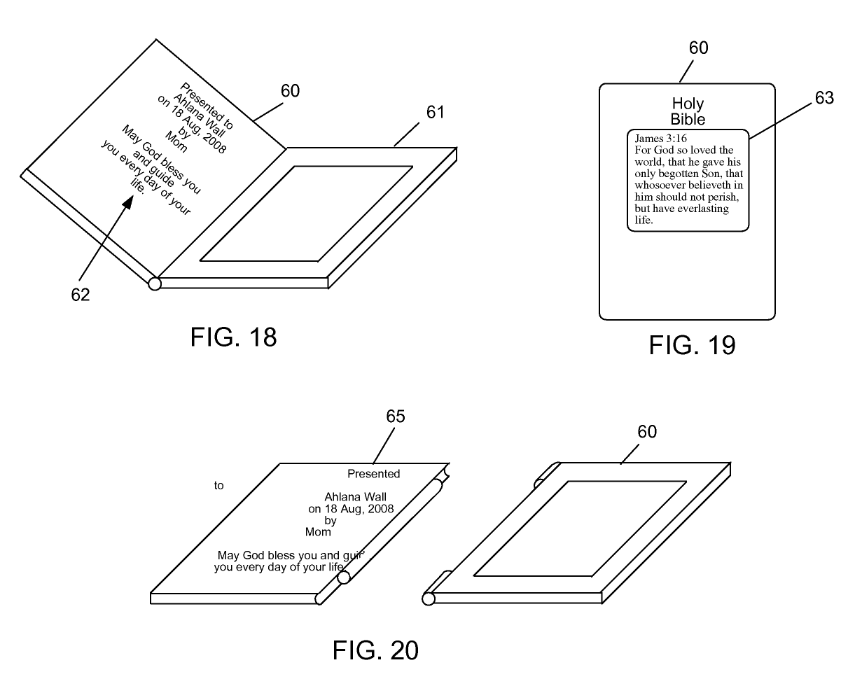

FIG. 18 shows another preferred embodiment of the present invention that includes cover 60. Cover 60 is attached via a hinge to base 61. By attaching a cover to the base, the electronic Bible more closely resembles traditional book style Bible. As with many traditional Bibles, the inside of cover 60 preferably includes dedication 62.

FIG. 19 shows a top view of cover 60 when it is closed over base 61. The front of cover 60 includes screen 63. In a preferred embodiment, screen 63 displays a preprogrammed verse-of-the-day. This verse preferably changes daily and assists the user in learning the most important verses of the Bible.

FIG. 20 shows another preferred embodiment of the present invention. In FIG. 20, cover 65 is removably attached to base 60. The removable attachment of cover 65 gives the user the option of using his electronic bible with or without a cover.

### Other Preferred Embodiments

Although the above discussion disclosed specific features of a preferred embodiment, it should be understood that many variations are possible. For example, it should be noted that font style, font color and screen color can be modified according to the preference of the user. These preferences can be selected by the user tapping on a “Custom” button.

The on-off switch can be of a variety of types, including a sliding switch (as discussed above) or a push on-off switch.

Also, in an alternative preferred embodiment, on the side of each verse different verse numbers can be placed that pertain to the same subject. The user can then tap on the verse he wants in order to be taken there. Or, alternatively, the user can tap to have all the verses brought up together so that he can read them one after the other.

Also, alternatively, the user can choose a book first to cause the book to appear on the screen. For example, if the user taps on “Proverbs”, then the book of “Proverbs” will appear on the screen. Then, to go to a specific verse, the user can tap on the verse number he wants, write in the verse number with his stylus, scroll down the screen until he gets to the verse he wants, or tap on a “Next Page” button to get to the verse he wants.

Also, alternatively, for definitions while reading a verse the user can tap on a word that he wants defined. Then, instead of being sent to a new page a pop up bubble will appear with the definition and a list of any other related verses that pertain to the word.

Also, alternatively, for the memorize page, verses to memorize can be separated into categories (for example, love, death, etc.). Verses to memorize can also be separated into New Testament and Old Testament. Verses to memorize can also be categorized by Books. The user can also preferably choose how many verses he wants to memorize at a time and which verse to memorize.

Also, alternatively, the preferred embodiment includes a sensor that determines if the user is holding the electronic Bible horizontal or vertical. If the user is holding the Bible horizontal so that the screen is in a landscape horizontal orientation, the sensor will automatically adjust the display so that it is horizontal. Conversely, if the screen is in a vertical display the sensor will automatically adjust the display so that it is vertical.

Also, alternatively, the electronic Bible is programmed to display a variety of languages. The user selects the desired language for the Bible to display.

Also, alternatively, the electronic Bible includes a Maps tab to view maps of the various places the Bible discusses. The maps preferably show both the view from Biblical times and modern times. Preferably, when a name of a city, location, place or country is mentioned in a verse the user can tap on it with his stylus in order to view a corresponding map.

Also, alternatively, the electronic Bible includes a USB connection for connecting other devices to the Bible.

Also, alternatively, the electronic Bible is programmed to display a variety of versions. The user selects the desired version for the Bible to display. For example, a user may wish to view the King James Version of the Bible while reading Proverbs 2:3: Then, the user can compare this to the American Standard Version of the Bible for Proverbs 2:3 for study and understanding.

Also, alternatively, the electronic Bible can include a “Book Mark” button. As the user is reading the electronic Bible, in addition to highlighting (or instead of highlighting) he can tap on a verse to book mark that verse if he finds it of high interest or importance. This verse is then saved as a book marked section. All the saved book mark sections can be accessed at once by tapping on the “Book Mark” button.

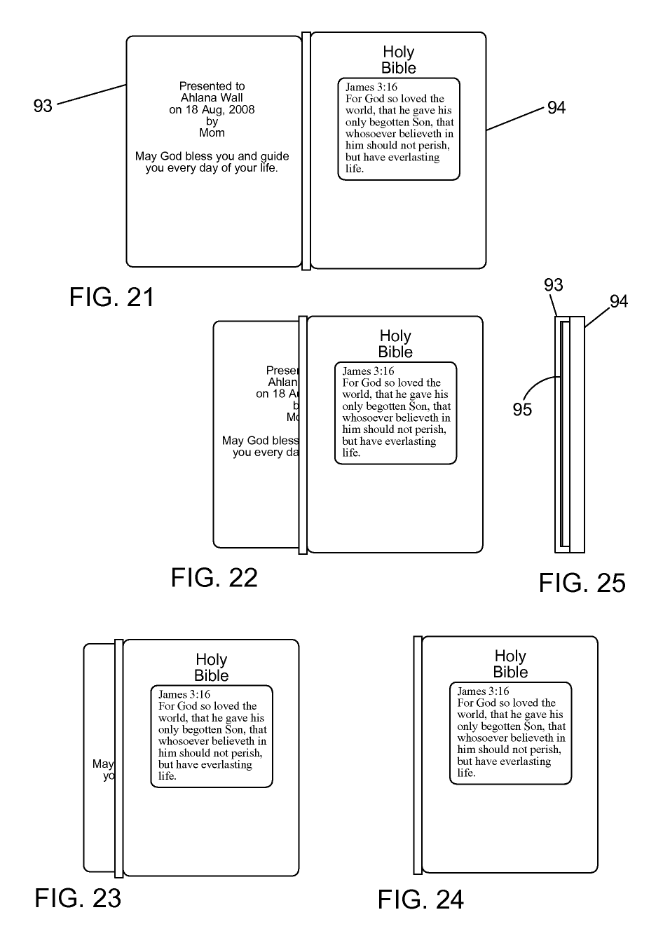

Also, alternatively, the cover of the Bible can be modified in a variety of ways. For example in another preferred embodiment once cover 93 is opened it can be slid behind base 94 via slot 95 (FIGS. 21-25): This makes physically holding and handling the electronic Bible easier.

While the above description contains many specifications, the reader should not construe these as limitations on the scope of the invention, but merely as exemplifications of preferred embodiments thereof. Those skilled in the art will envision many other possible variations are within its scope. For example, although the above description of the preferred embodiments discussed the Christian Bible having the Old and New Testaments, it should be understood that the present invention can be programmed to include the text of other types of Bibles and religious books. For example, it could be programmed to include the Jewish Bible or the Buddhist Bible, as well as many others. Accordingly the reader is requested to determine the scope of the invention by the appended claims and their legal equivalents, and not by the examples which have been given.

What is claimed is:

1) A hand-held electronic Bible for, comprising:
A) a screen adapted to display biblical text and to receive inputs from a user in the form of touch command and hand written instructions,
B) a stylus for touching and writing on said screen to enter inputs and commands into said electronic Bible,
C) a computer processor programmed with handwriting recognition software for receiving handwritten inputs and commands from a user and for converting said handwritten inputs and commands into computer readable inputs and commands, adapted to store biblical text in electronic form and to control operation of said electronic Bible in order to:
1) display biblical text on said screen,
2) receive said handwritten inputs from a user,
3) process said handwritten inputs in order to display biblical text requested by the user.

2) The hand-held electronic Bible as in claim 1, wherein said electronic Bible is a preprogrammed tablet PC.

3) The hand-held electronic Bible as in claim 1, wherein said electronic Bible is programmed to display on said screen:
A) a books button,
B) a memorize button,
C) a dictionary button, and
D) a notes button.

4) The hand-held electronic Bible as in claim 3, wherein tapping on said books button with said stylus causes said screen to display a books page, said books page comprising:
A) a listing of the books of the Old and New Testaments, and
B) a means for allowing a user to enter commands via said stylus to view a chapter and verse of a selected book from said listing of books.

5) The hand-held electronic Bible as in claim 3, wherein tapping on said memorize button with said stylus causes said screen to display a memorize page, said memorize page comprising:
A) a listing of chapters and verses for memorization, and
B) a means for allowing a user to enter commands via said stylus to view a selected chapter and verse for memorization.

6) The hand-held electronic Bible as in claim 3, wherein tapping on said dictionary button with said stylus causes said screen to display a dictionary page, said dictionary page comprising:
A) a listing of biblical words, and
B) a means for allowing a user to enter commands via said stylus to view definitions for a selected biblical word.

7) The hand-held electronic Bible as in claim 3, wherein tapping on said notes button with said stylus causes said screen to display a notes page, said notes page comprising:
A) a means for allowing a user to write notes via said stylus,
B) programming to allow said handwriting recognition software to convert said handwritten notes to computer readable text,
C) a means for saving said notes, and
D) a means for opening and reading said saved notes.

8) The hand-held electronic Bible as in claim 1, wherein said electronic Bible further comprises:
A) a base section comprising said screen,
B) a cover section pivotally and removably connected to said base section, said cover section further comprising:
1) a cover display screen for displaying computer generated biblical text, and
2) a cover dedication section for displaying Bible dedication information.

9) A hand-held electronic Bible for, comprising:
A) a screen adapted to display biblical text and to receive inputs from a user in the form of touch command and hand written instructions,
B) a stylus for touching and writing on said screen to enter inputs and commands into said electronic Bible,
C) a computer processor programmed with handwriting recognition software for receiving handwritten inputs and commands from a user and for converting said handwritten inputs and commands into computer readable inputs and commands, adapted to store biblical text in electronic form and to control operation of said electronic Bible in order to:
4) display biblical text on said screen,
5) receive said handwritten inputs from a user,
6) process said handwritten inputs in order to display biblical text requested by the user,
D) a books button, wherein tapping on said books button with said stylus causes said screen to display a books page, said books page comprising:
1) a listing of the books of the Old and New Testaments, and
2) a means for allowing a user to enter commands via said stylus to view a chapter and verse of a selected book from said listing of books,
E) a memorize button, wherein tapping on said memorize button with said stylus causes said screen to display a memorize page, said memorize page comprising:
1) a listing of chapters and verses for memorization, and
2) a means for allowing a user to enter commands via said stylus to view a selected chapter and verse for memorization,
F) a dictionary button, wherein tapping on said dictionary button with said stylus causes said screen to display a dictionary page, said dictionary page comprising:
1) a listing of biblical words, and
2) a means for allowing a user to enter commands via said stylus to view definitions for a selected biblical word, and
G) a notes button, wherein tapping on said notes button with said stylus causes said screen to display a notes page, said notes page comprising:
1) a means for allowing a user to write notes via said stylus,
2) programming to allow said handwriting recognition software to convert said handwritten notes to computer readable text,
3) a means for saving said notes, and
4) a means for opening and reading said saved notes.

10) The hand-held electronic Bible as in claim 9, wherein said electronic Bible further comprises:
A) a base section comprising said screen,
B) a cover section pivotally and removably connected to said base section, said cover section further comprising:
1) a cover display screen for displaying computer generated biblical text, and
2) a cover dedication section for displaying Bible dedication information.
